(19) United States
(12) Patent Application Publication
(10) Pub. No.: US 2025/0243589 A1
(43) Pub. Date: Jul. 31, 2025

(54) WATER ELECTROLYSIS CELL, WATER ELECTROLYSIS STACK

(71) Applicant: TOYOTA JIDOSHA KABUSHIKI KAISHA, Toyota-shi, (JP)

(72) Inventor: Naoki TAKEHIRO, Shizuoka-ken (JP)

(21) Appl. No.: 18/966,296

(22) Filed: Dec. 3, 2024

(30) Foreign Application Priority Data
Jan. 30, 2024 (JP) 2024-011820

(51) Int. Cl. C25B 1/04; C25B 9/21; C25B 9/23; C25B 11/032

(52) U.S. Cl. CPC C25B 1/04; C25B 9/21; C25B 9/23; C25B 11/032

(57) ABSTRACT

To provide a water electrolysis cell which reduces the concentration of hydrogen reaching the oxygen generating electrode side before the concentration increases with a simple configuration. An electrolyte membrane, a catalyst layer, and a separator for flowing a fluid are provided. A water electrolytic cell for generating hydrogen and oxygen by supplying water and applying a voltage, wherein a hydrogen reaction catalyst for promoting a reaction between hydrogen and oxygen is provided at a site where oxygen generated and residual water flow on the surface of the separator on the oxygen generating electrode side.

### FIELD

The present disclosure relates to a water electrolysis cell and a water electrolysis stack in which the water electrolysis cell is laminated.

### BACKGROUND

Patent Literature 1 discloses that a mixed gas of hydrogen and oxygen is reacted on a fluid passage connecting a water electrolysis apparatus and a hydrogen tank or an oxygen tank to be changed into water vapor, thereby reducing the concentration of gas hydrogen or oxygen. The produced water vapor is separated on the way.

### CITATION LIST

### Patent Literature

Patent Literature 1: WO 2019/008799 A1

### SUMMARY

### Technical Problem

In the prior art as in Patent Literature 1, a reaction device is required separately from the outside of the water electrolysis device, thereby inhibiting miniaturization of the entire water electrolysis system. In addition, there is a possibility that a mixed gas of hydrogen and oxygen having a high density is generated when the gas-liquid is separated, and thus, it is necessary to control the concentration of a large amount of gas.

In view of the above problems, it is an object of the present disclosure to provide a water electrolysis cell which, with a simple configuration, reduces the concentration of hydrogen that has reached the oxygen generating electrode side before the concentration increases.

### Solution to Problem

The present application discloses a water electrolysis cell comprising an electrolyte membrane, a catalyst layer, and a separator for flowing a fluid, wherein hydrogen and oxygen are generated by supplying water and applying a voltage, and wherein a hydrogen reaction catalyst for promoting a reaction between hydrogen and oxygen is provided at a site where oxygen generated and residual water flow out of the surface of the separator on the oxygen generating electrode side.

The site where the hydrogen reaction catalyst is disposed may be provided with a structure for generating a turbulent flow in the remaining water.

Structures that generate turbulence can be grooves and/or embossments provided in the derivation region, which is the region leading to the discharge hole of the residual water.

In addition, the hydrogen reaction catalyst may be provided in a channel in which residual water on the downstream side of the region to be subjected to water electrolysis is discharged out of the surface of the separator.

The hydrogen reaction catalyst may be disposed on a surface of the surface of the separator facing the frame separating the oxygen generation pole and the hydrogen generation pole.

The hydrogen reaction catalyst may be disposed on a surface of the separator facing the adjacent water electrolysis cell.

The hydrogen reaction catalyst may be disposed on the surface of the frame that divides the oxygen generation pole and the hydrogen generation pole.

### Advantageous Effects

According to the present disclosure, since the hydrogen gas permeated into the oxygen generating electrode side in the water electrolysis cell is reacted with oxygen, it is not necessary to provide a large-scale device for reducing the concentration of the hydrogen gas on the downstream side of the oxygen generating electrode side path of the system, and thus it is possible to reduce the size of the system. Further, it is also possible to facilitate the hydrogen concentration control.

### BRIEF DESCRIPTION OF DRAWINGS

FIG. 1 is a plan view of the water electrolysis cell 10.

FIG. 2 is a conceptual diagram illustrating the layered structure of the water electrolysis cell 10 10a the water electrolysis area.

FIG. 3 is a conceptual diagram illustrating a layered configuration at a site of an oxygen electrode deriving-side distribution region 10d and an oxygen electrode deriving region 10e of the water electrolysis cell 10.

FIG. 4 It is a diagram for explaining an exemplary form of a groove 14h is structured to generate turbulence.

FIG. 5 It is a diagram for explaining an exemplary form of a groove 14h is structured to generate turbulence.

FIG. 6 It is a diagram for explaining an exemplary form of a groove 14h is structured to generate turbulence.

FIG. 7 It is a diagram illustrating a form of the frame 18.

FIG. 8 It is a diagram for explaining another aspect of the flow of the fluid on the oxygen generating electrode side.

FIG. 9 is a conceptual diagram illustrating the structure of the water electrolysis stack 30.

FIG. 10 is a diagram illustrating a laminated structure of the water electrolysis cell 10 in the water electrolysis stack 30.

FIG. 11 is a conceptual diagram illustrating another form of layered structure in the laminated structure of the water electrolysis cell 10 at the sites of the oxygen electrode deriving side distribution region 10d and the oxygen electrode deriving region 10e.

### DESCRIPTION OF EMBODIMENTS

### 1. Water Electrolysis Cell

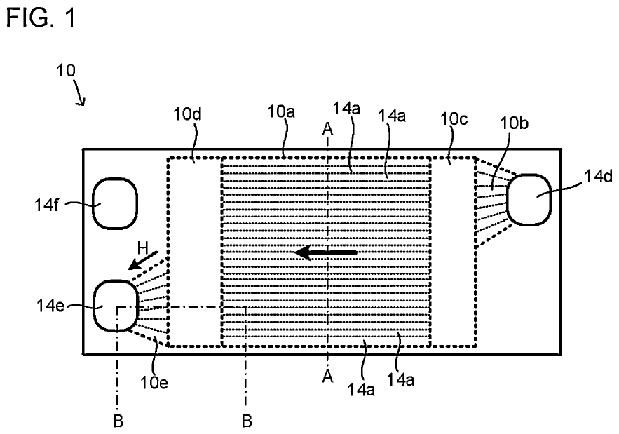

FIG. 1 shows a diagram illustrating the structure of the water electrolysis cell 10 according to one embodiment. The water electrolysis cell 10 is a unit element for decomposing pure water into hydrogen and oxygen, and a plurality of such water splitting cells 10 are laminated to constitute a water electrolysis stack. FIG. 1 is a plan view of the water electrolysis cell 10. In FIG. 1, in order to explain the internal structure of the water electrolysis cell 10, a portion of the internal structure (particularly, the oxygen generating electrode side) is represented by a dotted line.

Water electrolysis in the water electrolysis cell 10 is as known, but the outline thereof is as follows.

Pure water flows into the oxygen electrode introduction area 10b from the oxygen electrode introduction hole (oxygen electrode-side inlet manifold) 14d. Thereafter, the pure water reaches the water electrolysis region 10a after the uniformity of the distribution is enhanced in the oxygen-electrode introduction-side distribution region 10c, where water electrolysis is performed.

In the water electrolysis area 10a, a portion of pure water is decomposed into oxygen and hydrogen by a water electrolysis membrane electrode assembly to be described later, and is discharged through the respective flow paths. Oxygen generated and residual pure water is collected by the oxygen electrode lead-out flow path 10e through the oxygen electrode lead-out side distribution area 10d and discharged from the oxygen electrode lead-out hole (oxygen electrode side outlet manifold) 14e.

On the other hand, the generated hydrogen is transferred to the electrode (hydrogen generation electrode) opposite to the electrode (oxygen generation electrode) through which pure water flows with the water electrolytic membrane electrode assembly sandwiched therebetween, and is discharged from the hydrogen electrode lead-out hole (hydrogen electrode side outlet manifold) 14f through another channel (not shown) Both of the oxygen generating electrode and the hydrogen generating electrode are provided in the water electrolysis cell 10, but other than the water electrolysis area 10a, a respective flow path separated from each other is formed so as to be partitioned by a sealing member (not shown) so that the generated hydrogen and oxygen do not mix.

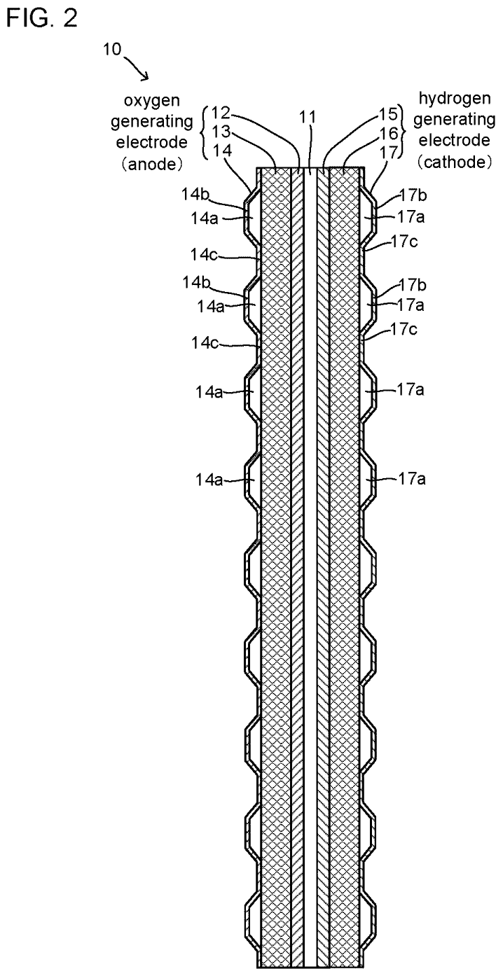

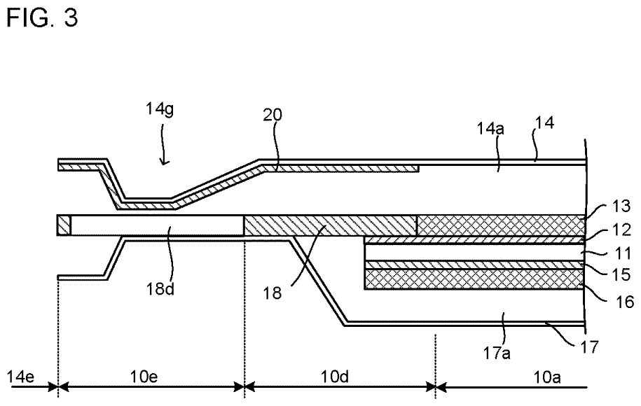

Hereinafter, a configuration of the water electrolysis cell 10 will be described. FIG. 2 is a view illustrating a layered structure in the water electrolysis area 10a in which water electrolysis is performed in the water electrolysis cell 10, which is a part of the A-A cross section of FIG. 1. FIG. 3 is a B-B cross-section of FIG. 1, showing a portion of the oxygen electrode lead-out hole (oxygen electrode side outlet manifold) 14e, the oxygen electrode leading area 10e, the oxygen electrode lead-out side distribution region 10d, and a layer configuration of a portion of the water electrolysis region 10a.

The water electrolysis cell 10 is composed of a plurality of layers, and one of them becomes an oxygen generating electrode (anode) and the other becomes a hydrogen generating electrode (cathode) with the solid polymer electrolyte membrane 11 sandwiched therebetween.

In the water electrolysis area 10a, as shown in FIG. 2, the anode is laminated in this order from the solid polymer electrolyte membrane 11 side to the anode catalyst layer 12, the anode gas diffusion layer 13, and the anode separator 14. On the other hand, the cathode includes a cathode catalyst layer 15, a cathode gas diffusion layer 16, and a cathode separator 17 in this order from the side of the solid polymer electrolyte membrane 11 Here, the water electrolyte membrane electrode assembly means a stack of a solid polymer electrolyte membrane 11, an anode catalyst layer 12 disposed on an anode side of the solid polymer electrolyte membrane 11, and a cathode catalyst layer 15 disposed on a cathode side of the solid polymer electrolyte membrane 11 The thickness of the water electrolysis membrane electrode assembly is typically about 0.4 mm, and the thickness of the water electrolysis cell 10 in the water electrolysis area 10a is typically about 1.3 mm

At both ends of the water electrolysis area 10a of the water electrolysis cell 10, a frame 18 and a hydrogen-reacting section 20 are provided as shown in FIG. 3.

First, an embodiment of each layer will be described, and then a layer configuration in each region will be described.

### 1.1. Aspect of Each Layer

Each layer provided in the water electrolysis cell 10 has, for example, the following aspect. However, the water electrolysis cell of the present disclosure is not limited to the embodiment.

### Solid Polymer Electrolyte Membrane

The solid polymer electrolyte membrane 11 is an embodiment of an electrolyte membrane having proton conductivity. The material (electrolyte) constituting the solid polymer electrolyte membrane 11 in this form is a solid polymer material, and examples thereof include a proton conductive ion exchange membrane formed of a fluorine-based resin, a hydrocarbon-based resin material, or the like. It exhibits good proton conductivity (electrical conductivity) in the wet state. More specific examples thereof include a membrane made of Nafion (Nafion®) which is a perfluoro-based electrolyte.

The thickness of the solid polymer electrolyte membrane 11 is not particularly limited, but is 200 μm or less, preferably 100 μm or less, and more preferably 30 μm or less.

### Anode Catalyst Layer

The anode catalyst layer (oxygen electrode catalyst layer) 12 is a catalyst layer having a catalyst containing at least one or more of a noble metal catalyst such as Pt, Ru, Ir and an oxide thereof. More specific examples of the catalyst include Pt, iridium oxide, ruthenium oxide, iridium ruthenium oxide, or mixtures thereof.

Examples of the iridium oxide include iridium oxide (IrO₂, IrO₃), iridium tin oxide, and iridium zirconium oxide.

Examples of the ruthenium oxide include ruthenium oxide (RuO₂, Ru₂O₃), ruthenium tantalum oxide, ruthenium zirconium oxide, ruthenium titanium oxide, and ruthenium titanium cerium oxide.

Examples of the iridium ruthenium oxide include iridium ruthenium cobalt oxide, iridium ruthenium tin oxide, iridium ruthenium iron oxide, and iridium ruthenium nickel oxide.

The anode catalyst layer 12 may include an ionomer. In addition to improving coatability by including an ionomer, transmission of water supplied during water splitting can be smoothly performed due to its hydrophilicity. Examples of the ionomer to be included include an ionomer containing a perfluoro electrolyte which is an electrolyte used in a solid polymer electrolyte membrane.

### Anode Gas Diffusion Layer

The anode gas diffusion layer 13 is a gas diffusion layer disposed on the anode side, it is possible to use known ones, is constituted by a member having a gas permeability and conductivity. Specific examples thereof include a porous conductive member made of a sintered body such as metal fibers (e.g., titanium fibers) or metal particles (titanium particles)

### Anode Separator

The anode separator 14 is a member (separator) including a channel (water supply channel) 14a through which pure water and decomposed oxygen to be supplied to the anode gas diffusion layer 13 flow. The anode separator 14 in this embodiment is a member unevenness is repeated to form a plate-like member in the water electrolysis area 10a is arranged in contact with the anode gas diffusion layer 13 recess 14c, the anode gas diffusion layer 13 and the convex portion between 14b water supply flow path 14a is formed.

Anode separator 14 can be made by, for example, press molding a titanium thin film, the plate thickness is typically 0.1 mm to 0.2 mm, the height of the unevens is typically 0.5 mm degree.

Further, the anode separator 14, as shown in FIG. 1 and described above, the oxygen electrode side inlet manifold 14d is an inlet of pure water, the oxygen electrode side outlet manifold 14e is a discharge port of oxygen and remaining water generated, and the hydrogen electrode side outlet manifold 14f is a discharge port of hydrogen and accompanying water generated is provided.

Further, as shown in FIG. 3, the anode separator 14 of the present embodiment, the oxygen electrode lead-out area 10e, the squeezed portion 14g is provided so as to be convex toward the cathode separator 17. The restrictor 14g serves as one of the structures to generate turbulence, which can disturb the fluid flow at the surface of the anode separator 14 as will be described later, thereby promoting the hydrogen reaction by the hydrogen reaction section 20.

In addition, in the present embodiment, a grooved 14h may be provided on the surface of the anode separator 14 which becomes the cathode separator 17 side in the oxygen electrode lead-out side distribution region 10d and/or the oxygen electrode leading area 10e which is consecutive thereto. Groove 14h also serves as one of the structures to generate turbulence, thereby disturbing the fluid flow at the surface of anode separator 14 as will be described later and promoting the hydrogen reaction by hydrogen reaction section 20.

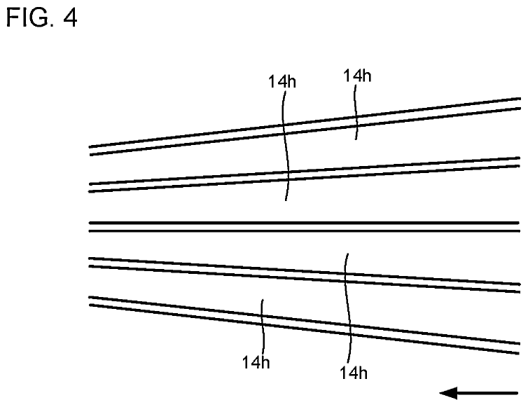

FIG. 4 to FIG. 6 schematically show typical configurations of the groove 14h. Incidentally, the direction of the linear arrow shown in FIGS. 4 to 6 is a direction indicated by H in FIG.

In FIG. 4, the groove 14h extends in a shape where the groove width changes.

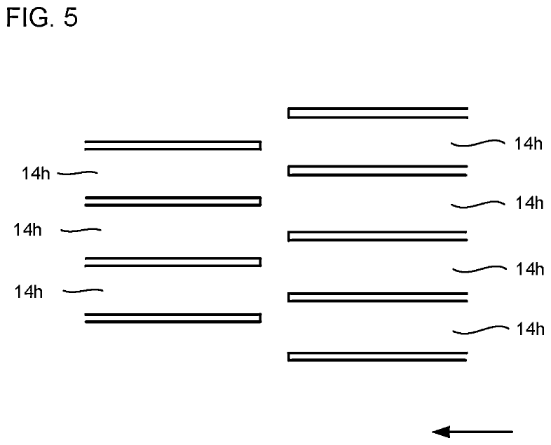

The shape of FIG. 5 is configured so that the position of the groove in the direction in which the groove 14h extends is shifted in the groove width direction.

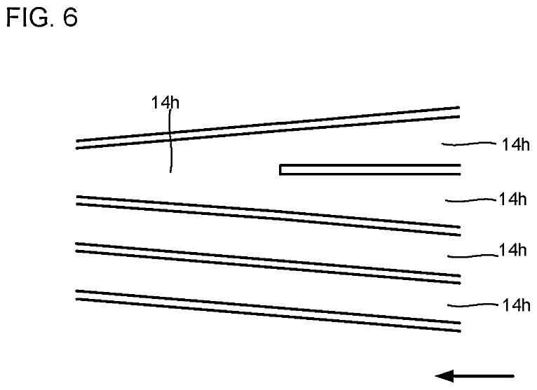

Example of FIG. 6 is an example in which the groove 14h adjacent in the direction in which the groove 14h extends merges (groove separating in the middle may be formed.)

In addition, as an example of the form of a structure that generates turbulence, a straight shape in a direction in which the groove width is constant and the groove extends, a wavy shape, or an embossed uneven may be used.

In addition, in the front and back of the anode separator 14, a conductive layer may be provided at a portion corresponding to the water-electrolyzed region 10a in order to reduce the electric contactresistance. The material constituting the conductive layer may be any material having conductivity, and examples thereof include platinum.

### Cathode Catalyst Layer

The cathode catalyst layer 15 is a catalyst layer containing a catalyst, and a catalyst contained in the cathode catalyst layer 15 may be a known catalyst, and examples thereof include platinum, platinum coated titanium, platinum supported carbon, palladium supported carbon, cobalt trioxime, and nickel glyoxime.

The cathode catalyst layer 15 may include an ionomer. By including an ionomer, coatability can be improved. Examples of the ionomer to be included include an ionomer comprising a perfluoro electrolyte which is an electrolyte used in a solid polymer electrolyte membrane.

### Cathode Gas Diffusion Layer

Cathode gas diffusion layer 16 is a gas diffusion layer disposed on the cathode side, it is possible to use known ones, is constituted by a member having a gas permeability and conductivity. Specific examples thereof include porous members such as carbon cloth and carbon paper.

### Cathode Separator

The cathode separator 17 is a member including a channel 17a through which hydrogen ions generated by reduction of hydrogen ions and water (accompanying water) accompanying the hydrogen ions permeate through the solid polymer electrolyte membrane 11 reach. Cathode separator 17 in this embodiment is a member unevenness is repeated to form a plate-like member in the water-electrolysis area 10a is placed in contact with the cathode gas diffusion layer 16, the cathode gas diffusion layer 16 and the convex portion 17b flow path 17a for hydrogen discharge is formed between.

The cathode separator 17 can be manufactured, for example, by press-molding a titanium thin film, and the plate thickness thereof is typically 0.1 mm to 0.2 mm, and the height of the unevenness is typically about 0.5 mm

Further, the cathode separator 17, as shown in FIG. 1 and described above, the oxygen electrode side inlet manifold overlapping the oxygen electrode side inlet manifold 14d (not shown), the oxygen electrode side outlet manifold overlapping the oxygen electrode side outlet manifold 14e described above (not shown), and the hydrogen electrode side outlet manifold overlapping the hydrogen electrode side outlet manifold 14f (not shown) is provided.

Among the front and back surfaces of the cathode separator 17, a conductive layer may be provided at a portion corresponding to the water-electrolyzed region 10a in order to reduce the electric contactresistance. The material constituting the conductive layer may be any material having conductivity, and examples thereof include platinum.

### Frame

Frame 18 is disposed between the anode separator 14 and the cathode separator 17 in the outer peripheral portion of the water electrolysis cell 10 to seal the inside, it functions as a seal member for sealing so as to isolate the oxygen generating electrode side and the hydrogen generating electrode side.

Accordingly, the frame 18 surrounds the water electrolysis region 10a, the oxygen electrode introduction region 10b, the oxygen electrode introduction side dispersion region 10c, the oxygen electrode derivation side dispersion region 10d, the oxygen electrode derivation region 10e, and the like, and is disposed so as to be sandwiched between the anode separator 14 and the cathode separator 17

Frame 18, for example, in the cross-section of FIG. 3, from the water supply flow path 14a of the anode separator 14 oxygen electrode leading side distribution region 10d, since flowing oxygen and residual water generated in the oxygen electrode side outlet manifold 14e through the oxygen electrode leading region 10e is not sealed in the part. On the other hand, in the cross-section of FIG. 3, the flow of hydrogen from the flow path 17a of the cathode separator 17 to the oxygen-electrode-side inlet manifold 14e is sealed so as to be blocked. Thus, the frame 18 is adjusted in contact (seal) with the anode separator 14 and cathode separator 17 so that the fluid flow is adequate.

The frame 18 is made of a thermoplastic resin material having electrical insulation and airtightness and having a relatively high melting point. Such materials may include crystalline polymers, and more specifically engineering plastics. Examples of the engineering plastic include a polyethylene naphthalate-based resin (PEN) and a polyethylene terephthalate-based resin (PET)

The thickness of the frame is not particularly limited, but is preferably 0.05 mm or more and 0.25 mm or less.

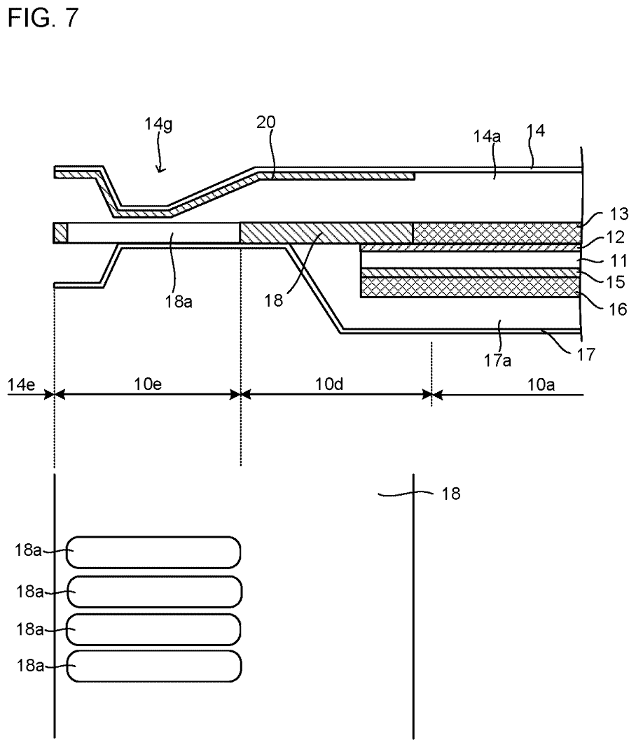

In this form, a plurality of hole 18a may be provided at positions of the frame 18 which become the oxygen electrode derivation regions 10e FIG. 7 shows a diagram for illustration. In FIG. 7 shows a view of the same viewpoint as FIG. 3 on the paper, below the paper, a view taken as a plan view in the frame 18 portion.

The site leading to the oxygen electrode outlet manifold 14e at the position of the frame 18 to be the oxygen electrode lead-out area 10d in this way, not just one cut-out, is constituted by a plurality of hole 18a. By setting the plurality of hole 18a, it is possible to function as a structure which generates turbulent flow, and to disturb the flow of the fluid on the surface of the anode separator 14 as described later, thereby promoting the hydrogen reaction by the hydrogen reaction unit 20

### Hydrogen Reaction Section

The hydrogen reaction unit 20 is a site for converting hydrogen reached here into water by reacting with oxygen. Therefore, in this form, a hydrogen reaction catalyst is disposed in the hydrogen reaction unit 20, thereby promoting the reaction. The hydrogen reaction catalyst is not particularly limited, and examples thereof include platinum. When platinum is used, the film thickness is preferably 100 nm or less from the viewpoint of reducing the amount of noble metal used, and more preferably, the film thickness is 30 nm or less. Although there is no particular limitation on the method of forming a film of platinum, for example, a so-called surface treatment method may be used. Specific examples of the surface treatment method include ion plating, sputtering, and plating.

The hydrogen reaction portion may be arranged so as to cover the entire predetermined range with a constant film thickness, but is not limited thereto, and may be dotted in islands or alternately arranged in stripes.

The site at which the hydrogen reaction section 20 is provided is a region where the generated oxygen and the remaining water flow. Therefore, specifically, the hydrogen reaction catalyst can be provided in a flow path in which residual water on the downstream side of the region to be subjected to water electrolysis is discharged out of the surface of the separator. More specifically, among the inner surfaces of the anode separator 14 (the surface on the side on which the water electrolytic membrane electrode assembly is disposed) as shown in FIG. 3, there may be mentioned an oxygen electrode lead-out side distribution region 10d and/or an oxygen electrode leading area 10e, and an inner surface of the channel (a surface facing the frame 18) in which a flow path through which oxygen and residual water flow is formed. In addition to this, or alternatively, a hydrogen reaction portion may be formed on the surface of the frame 18 (the surface on the oxygen electrode side)

Thus, hydrogen mixed in the generated oxygen and the remaining water (permeated from the hydrogen generating electrode side) can be reacted with oxygen at the inner surface of the flow path formed by the anode separator to form water.

When the remaining water discharged from the water electrolysis cell 10 is supplied again to the water electrolysis cell 10 after the treatment, there is a possibility that the water to be supplied contains hydrogen, and therefore, a hydrogen reaction section may also be provided in the flow path of the oxygen electrode introduction region 10c and the subsequent oxygen electrode introduction side distribution region 10c

### 1.2. Layer Configuration in the Water Electrolysis Region

As shown in FIG. 2, the layer structure of the water electrolysis area 10a is such that the anode is laminated in this order from the side of the solid polymer electrolyte membrane 11 to the anode catalyst layer 12, the anode gas diffusing layer 13, and the anode separator 14. On the other hand, the cathode includes a cathode catalyst layer 15, a cathode gas diffusion layer 16, and a cathode separator 17 in this order from the side of the solid polymer electrolyte membrane 11

The anode separator 14 includes a channel (water supply channel) 14a through which pure water and decomposed oxygen are supplied to the anode gas diffusion layer 13 In this embodiment, the anode separator 14 forms a plate-like member in a wavy shape in the water electrolysis area 10a and unevens are repeated, by the recess 14c is disposed in contact with the anode gas diffusion layer 13, the anode gas diffusion layer 13 and the water supply flow path 14a is formed between the convex portion 14b.

The cathode separator 17 includes a channel 17a through which hydrogen generated by reduction of hydrogen ions and water (accompanying water) accompanying the hydrogen ions permeate through the solid polymer electrolyte membrane 11 reach. Cathode separator 17 in the present embodiment is repeated irregularities to form a plate-like member in the water-electrolysis area 10a, by the recess 17c is disposed in contact with the cathode gas diffusion layer 16, the cathode gas diffusion layer 16 and the convex portion 17b flow path 17a for hydrogen discharge is formed between.

### 1.3. Layer Structure of the Oxygen Electrode Derivation Side Distribution Region and the Oxygen Electrode Derivation Region

The oxygen electrode derivation side distribution region 10d and the oxygen electrode derivation region 10e are regions through which oxygen and residual water generated in the water electrolysis region 10a pass by the time they are discharged to the oxygen electrode side outlet manifold 14e

In the oxygen electrode deriving-side distribution area 10d, as can be seen from FIG. 3, the solid polymer electrolyte membrane 11, the anode catalyst layer 12, the anode gas diffusion layer 13, the cathode catalyst layer 15, and the end face of the cathode gas diffusion layer 16 are formed. Here, the end face of the anode gas diffusion layer 13 is formed at a position slightly retracted compared to the other end face. Then, it is laminated to the anode catalyst layer 12, the frame 18 is disposed so as to extend from the end face of the anode gas diffusion layer 13. The frame 18 is provided to extend into the oxygen electrode lead-out area 10e and to the oxygen electrode outlet manifold 14e. Further, the cathode separator 17 in the oxygen-electrode lead-side distribution area 10d is bent in the thickness direction (stacking direction of each layer) until it comes into contact with the surface of the frame 18, the hydrogen-generating electrode side is sealed.

In the oxygen-electrode lead-out area 10e, the diaphragm 14g is formed so that the anode separator 14 is bent so as to approach the frame 18, and the flow passage is narrowed in the thickness direction.

In this form, as described above, in the oxygen electrode lead-out side distribution region 10d and the oxygen electrode leading area 10e, the hydrogen-reaction portion 20 is disposed on the surface of the surface of the channel formed by the anode separator 14 on the side of the frame 18

### 1.4. Effect, etc.

According to the water electrolysis cell 10 of the present disclosure, it acts, for example, as follows.

When pure water is supplied from the oxygen electrode side inlet manifold 14d, pure water reaches the water electrolysis region 10a through the oxygen electrode introduction region 10b and the oxygen electrode introduction side distribution region 10c In the water electrolysis area 10a, pure water (H₂O) supplied from the water supply channel 14a to the anode (oxygen generation electrode) is decomposed into oxygen, electrons and protons (H⁺) in the anode catalyst layer 12 having a potential by energizing between the anode and the cathode. At this time, protons pass through the solid polymer electrolyte membrane 11 and move to the cathode catalyst layer 15 On the other hand, electronics separated by the anode catalyst layer 12 pass through an external circuit and reach the cathode catalyst layer 15 Then, protons receive electronics in the cathode catalyst layer 15, hydrogen (H₂) is generated, and reaches the cathode gas diffusing layer 16 Incidentally, in the cathode gas diffusion layer 16 accompanied water is present together with the generated hydrogen gas.

Hydrogen gas and associated water present in the cathode gas diffusion 16 reaches the cathode separator 17, it flows through the flow path 17a is discharged from the hydrogen electrode-side outlet manifold 14f (hydrogen electrode outlet hole).

On the other hand, the oxygen generated in the anode catalyst layer 12 and the unused residual water return to the anode separator 14 and are discharged from the oxygen electrode outlet manifold 14e through the hydrogen supply channel 14a through the oxygen electrode lead-out side distribution region 10d and the flow channel of the oxygen electrode leading area 10e

Here, there is a case where hydrogen permeated from the hydrogen generating electrode is mixed into the residual water discharged from the hydrogen supplying channel 14a In contrast, in the water electrolysis cell 10 of the present disclosure, as described above, the oxygen electrode lead-out side distribution region 10d and the hydrogen reaction portion 20 are provided on the inner surface of the flow path of the oxygen electrode leading area 10e, and the hydrogen mixed therein can be reacted with oxygen and changed into water. Thus, it is possible to reduce the amount of hydrogen contained in the residual water collected on the downstream side, and it is possible to eliminate the need for an equipment for separately treating hydrogen or to reduce the scale thereof. It also facilitates the management of gases to be treated.

As in the above-described form, by providing a structure which generates a turbulent flow such as a throttle portion 14g, a groove 14h, and a hole 18a of the frame 18, it is possible to easily reach the hydrogen reaction portion 20 and to efficiently convert the hydrogen mixed with the generated oxygen by disturbing the flow of the remaining water flowing.

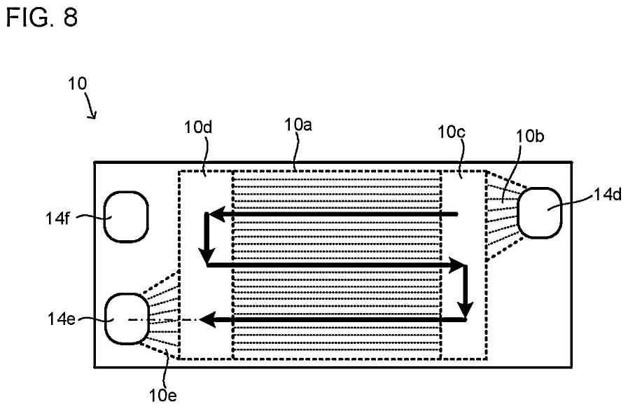

Note that, in the water electrolysis cell 10 described above, pure water supplied is basically flowing in one direction (from the right to the left of the paper surface) of the water electrolysis region 10a, but in place of this, a partition may be provided as indicated by a straight arrow in FIG. 8, or the like, and the pure water may be configured to flow so as to be folded back in the distribution region 10c, 10d provided at both ends of the water electrolysis region 10a

### 2. Water Electrolysis Stack

### 2.1. Basic Structure of the Water Electrolysis Stack

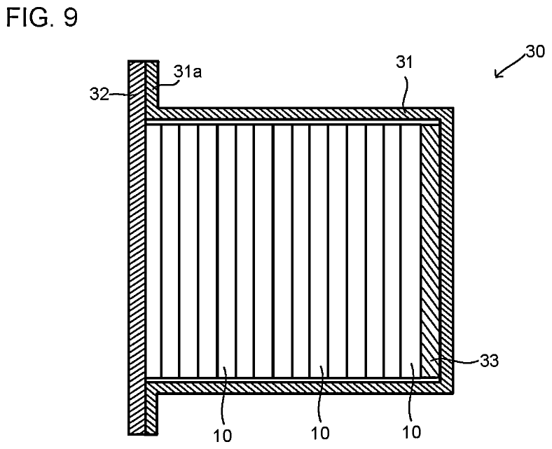

The water electrolysis stack 30 is a member formed by stacking a plurality of (about 50 sheets to about 400 sheets) of the above-described water electrolysis cells 10, and energizes the plurality of water electrolysis cells 10 to generate hydrogen and oxygen. FIG. 9 shows the outline of the structure. The water electrolysis cell 30 includes a stack case 31, an end plate 32, a plurality of water electrolysis cells 10, and a biasing member 33

Stack case 31, a plurality of water electrolysis cells 10 stacked, and a housing for housing the biasing member 33 inside. Stack case 31 in the present embodiment is open at one end in a rectangular tubular shape, together with the other end is closed, the plate-shaped piece on the opposite side to the opening along the edge of the opening overhangs, to form a flanged 31a.

End plate 32 is a plate-like member, closing the opening of the stack case 31. End plate 32 so as to cover the stack case 21 by bolts and nuts or the like overlaps with the flanged 31a of the stack case 31 is fixed to the stack case 31.

The water electrolysis cell 10 is as described above. A plurality of such water electrolysis cells 10 are overlapped. Here, in this form, as can be seen from FIG. 9, the water electrolysis cell 10 is configured to be overlapped horizontally, the water electrolysis cell 10 is arranged so that the direction in which the water supply flow path 14a are aligned and the direction in which the flow path 17a are aligned are the vertical direction as shown in FIG. 1.

The biasing member 33 fits inside the stack case 31 and imparts a pressing force to the stack of water electrolysis cells 10 in the stacking direction thereof. Examples of the biasing member may include a dish spring.

### 2.2. Stacking Structure of the Water Electrolysis Cell

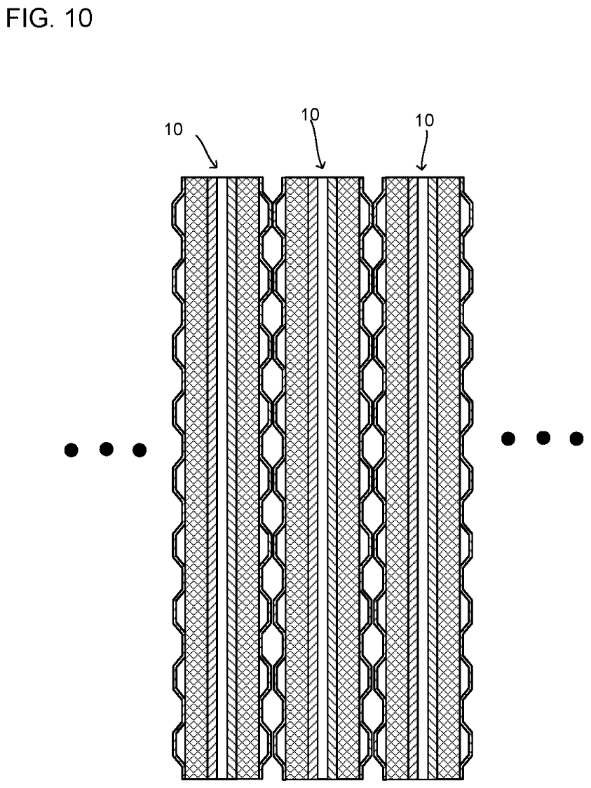

As described above, in the water electrolysis stack 30, a plurality of water electrolysis cells 10 are laminated. In FIG. 10, three of the laminated water electrolysis cell 10 was extracted to represent a cross section of a portion (a portion of the water electrolysis area 10a).

As can be seen from FIG. 10, when the water electrolysis cell 10 is stacked, the cathode separator 17 of one of the water electrolysis cells 10 and the anode separator 14 of the other water electrolysis cell 10 overlap each other in the adjacent water electrolysis cell 10 More specifically, the convex 17b of the cathode separator 17 of one water electrolysis cell 10 and the convex 14b of the anode separator 14 of the other water electrolysis cell 10 are contacted and overlapped with each other.

As described above, in the present embodiment, hydrogen is reacted with oxygen in each of the water electrolysis cells 10 to be converted into water, so that even a water electrolysis stack in which many water electrolysis cells 10 are laminated has the above-described effect, and the effect becomes more remarkable as a large number of water electrolysis cells 10 are laminated.

### 2.3. Other Forms of Example

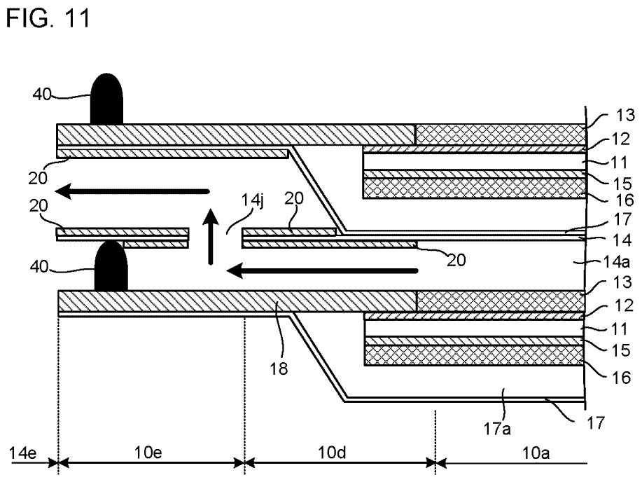

FIG. 11 shows a diagram illustrating another exemplary embodiment. In FIG. 11, a water electrolysis stack (i.e., a condition in which a plurality of water electrolysis cells 10 are stacked) shows a portion from the same viewpoint as in FIG. 3. In FIG. 11, one water electrolysis cell 10 and a part of one water electrolysis cell 10 laminated thereto are shown.

In this form, a sealant 40 is disposed between the anode separator 14 and the frame 18 in the oxygen electrode lead-out area 10e, and is configured so as not to pass from there to the oxygen electrode side outlet manifold 14e In this form, a hole 14j is provided in the oxygen electrode lead-out area 10e of the anode separator 14 instead, and a flow path is formed between the cathode separator 17 of the neighboring water electrolysis cell 10 so as to lead from the flow path to the oxygen electrode side outlet manifold 14e

According to this, the generated oxygen and residual water is the flow is disturbed because it is bent halfway as indicated by the straight arrow. Therefore, by providing the hydrogen reaction section 20 on the inner surface of the channel (the surface facing the adjacent water electrolysis cell) by the anode separator 14 and the cathode separator 17 of the adjacent water electrolysis cell 10 as shown in FIG. 11, it is possible to efficiently react the mixed hydrogen with oxygen. Such a form also provides the above-described effects.

### REFERENCE SIGNS LIST

10 . . . Water electrolysis cell, 10a . . . oxygen electrode introduction region, 10c . . . oxygen electrode introduction side distribution region, 10e . . . oxygen electrode lead out region, 11 . . . solid polymer electrolyte membrane, 12 . . . anode catalyst layer, 13 . . . anode gas diffusion layer (oxygen generating electrode gas diffusion layer), 14 . . . anode separator (oxygen generating electrode separator), 14a . . . feed channel, 14d . . . oxygen electrode inlet manifold (oxygen electrode inlet hole), 14e . . . oxygen electrode outlet manifold (oxygen electrode lead out hole), 14f . . . hydrogen electrode outlet manifold (structure to generate turbulence), 10b . . . ditch (structure to generate turbulence), 15 . . . Cathode catalyst layer, 16 . . . Cathode gas diffusion layer, 17 . . . Cathode separator (hydrogen generation electrode separator), 18 . . . Frame, 20 . . . Hydrogen reaction part (site provided with hydrogen reaction catalyst), 30 . . . Water electrolysis stack

What is claimed is:

1. A water electrolysis cell that generates hydrogen and oxygen by a supply of water and application of voltage, the water electrolysis cell comprising:
an electrolyte membrane;
catalyst layers; and
separators via which fluid flows, wherein
a hydrogen reaction catalyst that promotes reaction between hydrogen and oxygen is provided on a portion on a surface of one of the separators, the one separator being on a side of an oxygen generating electrode, generated oxygen and residual water flowing on the portion, the residual water being derived from the water.

2. The water electrolysis cell according to claim 1, further comprising:
a structure by which a turbulent flow is generated in the residual water at the portion where the hydrogen reaction catalyst is provided.

3. The water electrolysis cell according to claim 2, wherein
the structure by which the turbulent flow is generated is a groove and/or an embossed pattern, the groove and/or an embossed pattern being provided in a leading area that is an area leading to a discharge hole for the residual water.

4. The water electrolysis cell according to claim 1, wherein
the hydrogen reaction catalyst is provided in a channel that is on the surface of the one separator and on a downstream side of an area where water electrolysis is performed, the residual water is discharged via the channel.

5. The water electrolysis cell according to claim 4, wherein
the hydrogen reaction catalyst is provided on a part of the surface of the one separator, the part facing a frame that separates the oxygen generating electrode and a hydrogen generating electrode.

6. The water electrolysis cell according to claim 4, wherein
the hydrogen reaction catalyst is provided on a part of the surface of the one separator, the part facing another water electrolysis cell that is adjacent to the water electrolysis cell.

7. The water electrolysis cell according to claim 4, wherein
the hydrogen reaction catalyst is provided on a surface of a frame that separates the oxygen generating electrode and a hydrogen generating electrode.
